(19) United States
(12) Patent Application Publication
(10) Pub. No.: US 2009/0269264 A1
(43) Pub. Date: Oct. 29, 2009

(54) Carbon Dioxide Reforming Catalyst and Method for Manufacturing the Same

(75) Inventors: Yoshinori Saito, Otsu-shi (JP); Hideto Sato, Kusatsu-shi (JP)

Correspondence Address: DICKSTEIN SHAPIRO LLP, 1633 Broadway, NEW YORK, NY, 10019, US

(73) Assignee: Murata Manufacturing Co., Ltd.

(21) Appl. No.: 12/499,288

(22) Filed: Jul. 8, 2009

Related U.S. Application Data
(63) Continuation of application No. PCT/JP2008/050081, filed on Jan. 8, 2008.

(30) Foreign Application Priority Data
Jan. 9, 2007 (JP) JP2007-001277

(51) Int. Cl. B01D 53/62; B01J 27/232; B01J 32/00

(52) U.S. Cl. 423/230; 502/174; 502/439

(57) ABSTRACT

A carbon dioxide reforming catalyst and a manufacturing method thereof are provided, the catalyst enabling a hydrocarbon feedstock gas to react with carbon dioxide while carbon deposition is suppressed, efficiently generating hydrogen and carbon monoxide. A mixture containing a carbonate of at least one alkaline earth metal selected from the group consisting of Ca, Sr, and Ba and a catalytic metal promoting a decomposition reaction of a hydrocarbon feedstock gas is contained as a primary component. The catalytic metal can be a least one element selected from the group consisting of Ni, Rh, Ru, Ir, Pd, Pt, Re, Co, Fe, and Mo. In addition, ATiO₃ (where A is at least one alkaline earth metal selected from the group consisting of Ca, Sr, and Ba) can further be present. The manufacturing is performed through a step in which carbon dioxide is absorbed in an alkaline earth/Ti composite oxide having a carbon dioxide absorption ability.

This is a continuation of application Serial No. PCT/JP2008/050081, filed Jan. 8, 2008.

### TECHNICAL FIELD

The present invention relates to a carbon dioxide reforming catalyst that is used when a synthetic gas containing hydrogen and carbon monoxide is manufactured by carbon dioxide reforming of a hydrocarbon feedstock gas, to a method for manufacturing a synthetic gas using the carbon dioxide reforming catalyst, to a method for manufacturing the carbon dioxide reforming catalyst, and to a support for a carbon dioxide reforming catalyst.

### BACKGROUND ART

Since carbon dioxide is a major material causing the global warming, a reduction in discharge amount of carbon dioxide and effective use thereof have been regarded as urgent requirements in recent years.

In addition, despite being generated in technical fields of petroleum refining, petroleum chemistry, and the like, various hydrocarbon gases are not always efficiently utilized, for example, as feedstock gases for various substances, and a more effective method for converting hydrocarbon gases into other substances has been actually desired.

For manufacturing a synthetic gas containing hydrogen and carbon monoxide, a method is known (carbon dioxide reforming of a hydrocarbon) in which a saturated hydrocarbon, such as methane, functioning as a reducing agent is reacted with carbon dioxide in the presence of a catalyst so as to form hydrogen and carbon monoxide, which are industrially effective synthetic gases.

As carbon dioxide reforming catalysts for a hydrocarbon, catalysts in which nickel is supported on a base material of alumina or the like, and a ruthenium-supported catalyst (see Patent Document 1), and catalyst (see Patent Document 2) in which rhodium is supported on a base material of alumina or the like are known.

However, carbon deposition is liable to occur on the catalyst when a nickel-supported catalyst is used, and due to decrease in activity caused by this carbon deposition, there has been a problem in that stable and efficient apparatus operation is difficult to achieve.

Since a ruthenium-supported catalyst as disclosed in Patent Document 1 functions to suppress carbon deposition, the carbon deposition is suppressed as compared to that of a nickel-supported catalyst, and the activity can also be easily maintained; however, when an unsaturated hydrocarbon, such as ethylene, is also present in a feedstock, thermal carbon deposition and decrease in activity are liable to occur, and although having an effect to suppress carbon deposition, the ruthenium-supported catalyst is poisoned by an unsaturated hydrocarbon contained in a feedstock gas, so that a problem in that the activity is decreased occurs.

It has also been believed that a rhodium-supported catalyst as disclosed in Patent Document 2 in which rhodium is supported on a base material of alumina or the like has the same problem as described above.

Patent Document 1: Japanese Unexamined Patent Application Publication No. 8-231204

Patent Document 2: Japanese Unexamined Patent Application Publication No. 9-168740

### DISCLOSURE OF INVENTION

### Problems to be Solved by the Invention

An object of the present invention is to provide a carbon dioxide reforming catalyst that can solve the above problems and that, while carbon deposition is suppressed, can efficiently generate hydrogen and carbon monoxide by a reaction between a hydrocarbon feedstock gas and carbon dioxide (performing carbon dioxide reforming); a method using the carbon dioxide reforming catalyst for efficiently manufacturing a synthetic gas containing hydrogen and carbon monoxide; a method for manufacturing the carbon dioxide reforming catalyst; and a support for a carbon dioxide reforming catalyst.

### Means for Solving the Problems

In order to achieve the above object, a carbon dioxide reforming catalyst that reforms a hydrocarbon feedstock gas by carbon dioxide and that is used to generate a synthetic gas containing carbon monoxide and hydrogen, comprises, as a primary component, a mixture that contains a carbonate of at least one alkaline earth metal selected from the group consisting of Ca, Sr, and Ba and a catalytic metal promoting a decomposition reaction of a hydrocarbon feedstock gas.

Preferably, the catalytic metal is at least one selected from the group consisting of Ni, Rh, Ru, Ir, Pd, Pt, Re, Co, Fe, and Mo.

In addition, the carbon dioxide reforming catalyst preferably further comprises ATiO₃ (A being at least one alkaline earth metal selected from the group consisting of Ca, Sr, and Ba).

In addition, a method for manufacturing a carbon dioxide reforming catalyst comprises the step of absorbing carbon dioxide in an alkaline earth/Ti composite oxide having carbon dioxide absorption ability.

In addition, the method described above can comprise the steps of:

firing, in the presence of barium carbonate, at least one of a green sheet, a green sheet waste, a green sheet laminate waste, and a green sheet precursor, that contains at least one alkaline earth metal selected from the group consisting of Ca, Sr, and Ba, and Ti, preferably at a molar ratio (alkaline earth metal/Ti) of 0.9:1.1, and that includes, as a primary component, a substance having a perovskite structure as the primary crystalline structure, and that is used in a process for manufacturing an electronic element.

In addition, a method of Claim 6 for manufacturing a synthetic gas is:

a method for manufacturing a synthetic gas containing carbon monoxide and hydrogen by carbon dioxide reforming of a hydrocarbon feedstock gas, comprises the steps of:

performing carbon dioxide reforming of a feedstock gas containing methane as a primary component by using the carbon dioxide reforming catalyst described above.

In addition, a support for the carbon dioxide reforming catalyst that is used to generate a synthetic gas containing carbon monoxide and hydrogen by reforming a hydrocarbon feedstock gas using carbon dioxide comprises, as a primary component:

a carbonate of at least one alkaline earth metal selected from the group consisting of Ca, Sr, and Ba.

In addition, the support for the carbon dioxide reforming catalyst can further comprise ATiO₃ (where A is at least one alkaline earth metal selected from the group consisting of Ca, Sr, and Ba).

### ADVANTAGES

The carbon dioxide reforming catalyst includes a mixture as a primary component that contains a carbonate of at least one alkaline earth metal selected from the group consisting of Ca, Sr, and Ba, and a catalytic metal promoting the decomposition reaction of a hydrocarbon feedstock gas. When this carbon dioxide reforming catalyst is used, a hydrocarbon feedstock gas is reformed by carbon dioxide while carbon deposition is suppressed, and a synthetic gas containing carbon monoxide and hydrogen can be efficiently generated.

That is, when carbon dioxide and methane as a hydrocarbon are supplied to the carbon dioxide reforming catalyst of the present invention at a high temperature, for example, of 800 to 1,100° C., the catalyst functions to cause the following reactions.

CH₄ [symbol] C+2H₂ (1)

C+CO₂ [symbol] 2CO (2)

CH₄+CO₂ [symbol] 2H₂+2CO (3)

In the carbon dioxide reforming reaction of methane (CH₄), the decomposition reaction of CH₄ (1) and the reaction generating CO (2) are advanced, and as a result, the overall carbon dioxide reforming reaction is represented by (3).

Using a conventional catalyst using an oxide, such as alumina or silica, as a support, the reaction rate of (2) is lower than that of (1), and as a result, carbon deposition occurs.

On the other hand, the carbon dioxide reforming catalyst of the present invention particularly has an effect to promote reaction (2), and carbon generated according to reaction (1) that is started and promoted primarily as a function of the catalytic metal, can be removed by reaction (2). Hence, as a result, the carbon deposition can be suppressed.

In the present invention, the type of catalytic metal is not particularly limited, and various metals may be used; however, when at least one member selected from the group consisting of Ni, Rh, Ru, Ir, Pd, Pt, Re, Co, Fe, and Mo, is used as the catalytic metal, a carbon dioxide reforming catalyst that can efficiently perform a carbon dioxide reforming reaction can be obtained.

In addition, when ATiO₃ (A being at least one alkaline earth metal selected from the group consisting of Ca, Sr, and Ba) is further present, sintering of the carbonate is suppressed, and the reaction converting a hydrocarbon feedstock gas and carbon dioxide into carbon monoxide and hydrogen can be promoted.

A carbon dioxide reforming catalyst containing a catalytic metal and a mixed material of ATiO₃ and a carbonate of at least one alkaline earth metal selected from the group consisting of Ca, Sr, and Ba has the effect of promoting reaction (2), and hence carbon generated by the hydrocarbon decomposition reaction (methane decomposition reaction) (1) is efficiently advanced by the above catalytic metal component can be efficiently removed by reaction (2).

It has been believed that the carbonate of an alkaline earth metal, such as BaCO₃, is effective to promote reaction (2), and hence a carbon dioxide reforming catalyst that contains, as a primary component, a catalytic metal and a carbonate of the alkaline earth metal and that contains no ATiO₃ is also useful as a carbon dioxide reforming catalyst capable of suppressing carbon deposition. However, when using only BaCO₃, the surface area of the catalyst is decreased by sintering, and thereby the activity thereof tends to degrade; hence, a more careful selection of the reaction conditions, catalytic metal, and the like, must be performed.

On the other hand, when a carbon dioxide reforming catalyst in which a catalytic metal is blended with a mixed material of ATiO₃ and a carbonate of at least one alkaline earth metal selected from the group consisting of Ca, Sr, and Ba, the decrease in surface area can be suppressed, and the catalytic activity can be maintained, so that carbon dioxide reforming can be more reliably performed.

In addition, when the carbon dioxide reforming catalyst of the present invention is manufactured by a method including absorbing carbon dioxide, for example, in an alkaline earth/Ti composite oxide, such as Ba₂TiO₄, having a carbon dioxide absorption ability, a BaCO₃ phase can be efficiently formed on a catalyst surface, which constitutes a reaction site, and as a result, a mixture having superior properties can be obtained.

The carbon dioxide reforming catalyst of the present invention can be manufactured by firing, in the presence of barium carbonate, green sheets, green sheet wastes, green sheet laminate wastes, green sheet precursors, or the like, that contain a predetermined alkaline earth metal and Ti, preferably at a molar ratio (alkaline earth metal/Ti) of 0.9:1.1, that include, as a primary component, a substance having a perovskite structure as a primary crystalline structure, and that are used in a process for manufacturing an electronic element, and hence while resources are being reused, a carbon dioxide-gas absorber having a superior carbon dioxide-gas absorption ability can be efficiently obtained.

When the metal component to be used as a catalytic metal is not contained in green sheets, green sheet wastes, green sheet laminate wastes, green sheet precursors, or the like, the carbon dioxide reforming catalyst of the present invention can be obtained by addition of the catalytic metal, and when a catalytic metal is present, the carbon dioxide reforming catalyst of the present invention can be obtained without particularly adding the catalytic metal.

The green sheets are, for example, sheets that are formed from a slurry containing BaTiO₃ as a primary component and a binder mixed therewith for manufacturing an electronic element, and when becoming unnecessary after the formation of a ceramic product, the green sheets can be used as a feedstock of the carbon dioxide reforming catalyst of the present invention.

Green sheet wastes are, for example, unnecessary sheets or portions thereof remaining after necessary sheets or portions are used in ceramic manufacturing. They can be used as a feedstock of the carbon dioxide reforming catalyst of the present invention.

As the green sheet laminate wastes, for example, there may be mentioned unsintered laminate wastes present after laminating a plurality of the above green sheets provided with an electrode material printed thereon, followed by pressure bonding, and these can also be used as a feedstock of the carbon dioxide reforming catalyst of the present invention.

As the green sheet precursors, for example, there may be mentioned a ceramic slurry in which BaTiO₃ is dispersed in a dispersing agent together with a binder, and BaTiO₃ prepared to be dispersed in a dispersing agent, which have become unnecessary for manufacturing an electronic element. The green sheet precursors can be used as a feedstock of the carbon dioxide reforming catalyst of the present invention.

When carbon dioxide reforming of a feedstock gas primarily containing methane is performed by using the carbon dioxide reforming catalyst of the present invention, a synthetic gas containing carbon monoxide and hydrogen can be efficiently manufactured from a feedstock gas primarily containing methane.

In addition, the support of the present invention for a carbon dioxide reforming catalyst includes a substance as a primary component that contains a carbonate of at least one alkaline earth metal selected from the group consisting of Ca, Sr, and Ba, and when a catalytic metal is blended with the above support, the carbon dioxide reforming catalyst of the present invention can be easily and reliably obtained.

When the support comprises ATiO₃ (A being at least one alkaline earth metal selected from the group consisting of Ca, Sr, and Ba), and a catalytic metal is blended with the support, the carbon dioxide reforming catalyst of the present invention can be easily and reliably obtained.

### BRIEF DESCRIPTION OF DRAWINGS

FIG. 1 is a view showing a schematic structure of a test apparatus used for carrying out a manufacturing method of a synthetic gas according to an example of the present invention.

FIG. 2 is a view showing the change in composition of a reformed gas (outlet-side gas) with time obtained by a reforming test using a carbon dioxide reforming catalyst C according to an example of the present invention.

### REFERENCE NUMERALS

1 reaction tube
2 heater
3 carbon dioxide reforming catalyst
4 inlet of reaction tube
5 outlet of reaction tube

### BEST MODES FOR CARRYING OUT THE INVENTION

Hereinafter, with reference to examples of the present invention, the features of the present invention will be further described in detail.

### Example 1

### Manufacturing of Carbon Dioxide Reforming Catalysts

### (1) Manufacturing of Carbon Dioxide Reforming Catalyst A

Barium carbonate (BaCO₃) and titanium oxide (TiO₂) were weighed a so as to have a molar ratio of 1.0:1.0, and further, nickel oxide (NiO) was added thereto and mixed therewith so as to be 2 percent by weight. Next, pelletizing was performed after a binder was added to the mixture thus obtained, so that spherical pellets having a diameter of 2 to 5 mm were obtained.

The granular pellets thus obtained were fired at 1,000° C. for 1 hour in air, thereby obtaining the carbon dioxide reforming catalyst A that was a mixture containing BaTiO₃ and NiO.

From the weight change of the granular pellets before and after the firing and the result of XRD measurement, it was confirmed that the carbon dioxide reforming catalyst thus obtained was a mixture of BaTiO₃ and NiO.

At least part of the above NiO was reduced in a carbon dioxide reforming reaction step of a hydrocarbon feedstock gas so as to function as a catalytic metal promoting carbon dioxide reforming of a hydrocarbon feedstock gas.

### (2) Manufacturing of Carbon Dioxide Reforming Catalyst B

NiO was added to and mixed with BaCO₃ so as to be 2 percent by weight of the mixture. Next, pelletizing was performed after a binder was added to the mixture thus obtained, so that spherical pellets having a diameter of 2 to 5 mm were obtained. Next, these granular pellets thus obtained were fired at 900° C. for 1 hour in air, thereby obtaining the carbon dioxide reforming catalyst B that was a mixture containing BaCO₃ and NiO.

From the weight change of the granular pellets before and after the firing and the result of XRD measurement, it was confirmed that carbon dioxide reforming catalyst B was a mixture of BaCO₃ and NiO.

At least part of the above NiO was reduced in a carbon dioxide reforming reaction step of a hydrocarbon feedstock gas so as to function as a catalytic metal promoting carbon dioxide reforming of a hydrocarbon feedstock gas.

### (3) Manufacturing of Carbon Dioxide Reforming Catalyst C

BaCO₃ and TiO₂ were weighed so as to have a molar ratio of 2.0 to 1.0, and NiO was further added thereto and mixed therewith so as to be 2 percent by weight.

Next, pelletizing was performed after a binder was added to the mixture thus obtained, so that spherical pellets having a diameter of 2 to 5 mm were obtained.

Next, these granular pellets thus obtained were fired at 1,000° C. for 1 hour in air, so that a mixture of Ba₂TiO₄ and NiO was obtained. Subsequently, this mixture was fired at 700° C. for 1 hour in a stream containing 20% of CO₂ and 80% of N₂, thereby obtaining the carbon dioxide reforming catalyst C that was a mixture containing BaCO₃, BaTiO₃, and NiO.

From the weight change of the mixture of Ba₂TiO₄ and NiO before and after the firing and the result of XRD measurement, it was confirmed that carbon dioxide reforming catalyst C was a mixture of BaCO₃, BaTiO₃, and NiO.

As for BaCO₃ and BaTiO₃ forming this carbon dioxide reforming catalyst C, it was confirmed that from the above-described weight change before and after the firing and result of XRD measurement, that all Ba₂TiO₄ was decomposed into BaCO₃ and BaTiO₃, and that the molar ratio of BaCO₃ to BaTiO₃ was 1.0 to 1.0.

In the process for manufacturing a carbon dioxide reforming catalyst, after the Ba₂TiO₄ phase was synthesized, the BaCO₃ phase was formed by a reaction with CO₂; hence, the BaCO₃ phase could be efficiently formed on a catalyst surface, which was a reaction site. In the following carbon dioxide reforming catalysts D, E, and F, the same thing as described above also occurred.

Furthermore, in the carbon dioxide reforming catalyst C, at least part of the above NiO was reduced in a carbon dioxide reforming reaction step of a hydrocarbon feedstock gas so as to function as a catalytic metal promoting carbon dioxide reforming of a hydrocarbon feedstock gas.

### (4) Manufacturing of Carbon Dioxide Reforming Catalyst D

BaCO₃ and TiO₂ were weighed so as to have a molar ratio of 1.5 to 1.0, and NiO was further added thereto and mixed therewith so as to be 2 percent by weight. Next, pelletizing was performed after a binder was added to the mixture thus obtained, so that spherical pellets having a diameter of 2 to 5 mm were obtained.

Next, these granular pellets thus obtained were fired at 1,000° C. for 1 hour in air, so that a mixture of Ba₂TiO₄, BaTiO₃, and NiO was obtained.

The mixture was then fired at 700° C. for 1 hour in a stream containing 20% of CO₂ and 80% of N₂, thereby obtaining the carbon dioxide reforming catalyst D that was a mixture containing BaCO₃, BaTiO₃, and NiO.

From the weight change of the mixture before and after the firing and the result of XRD measurement, it was confirmed that the carbon dioxide reforming catalyst D thus obtained was a mixture of BaCO₃, BaTiO₃, and NiO.

As for BaCO₃ and BaTiO₃ forming this carbon dioxide reforming catalyst D, it was confirmed that from the above-described weight change before and after the firing and result of XRD measurement, that all Ba₂TiO₄ was decomposed into BaCO₃ and BaTiO₃, and that the molar ratio of BaCO₃ to BaTiO₃ was 0.5 to 1.0.

Also in the case of this carbon dioxide reforming catalyst D, at least part of the above NiO was reduced in a carbon dioxide reforming reaction step of a hydrocarbon feedstock gas so as to function as a catalytic metal promoting carbon dioxide reforming of a hydrocarbon feedstock gas.

### (5) Manufacturing of Carbon Dioxide Reforming Catalyst E

BaCO₃ and TiO₂ were weighed so as to have a molar ratio of 1.2 to 1.0, and NiO was further added thereto and mixed therewith so as to have a ratio of 2 percent by weight. Next, pelletizing was performed after a binder was added to the mixture thus obtained, so that spherical pellets having a diameter of 2 to 5 mm were obtained.

Next, these granular pellets thus obtained were fired at 1,000° C. for 1 hour in air, so that a mixture of Ba₂TiO₄, BaTiO₃, and NiO was obtained.

Further, this mixture was fired at 700° C. for 1 hour in a stream containing 20% of CO₂ and 80% of N₂, thereby obtaining the carbon dioxide reforming catalyst E that was a mixture containing BaCO₃, BaTiO₃, and NiO.

From the weight change of the mixture before and after the firing and the result of XRD measurement, it was confirmed that the carbon dioxide reforming catalyst E thus obtained was a mixture of BaCO₃, BaTiO₃, and NiO.

In carbon dioxide reforming catalyst E, it was confirmed that from the above-described weight change before and after the firing and result of XRD measurement, that all Ba₂TiO₄ was decomposed into BaCO₃ and BaTiO₃, and that the molar ratio of BaCO₃ to BaTiO₃ was 0.2 to 1.0.

Also in the case of this carbon dioxide reforming catalyst E, at least part of the above NiO was reduced in a carbon dioxide reforming reaction step of a hydrocarbon feedstock gas so as to function as a catalytic metal promoting carbon dioxide reforming of a hydrocarbon feedstock gas.

### (6) Manufacturing of Carbon Dioxide Reforming Catalyst F

BaCO₃ and TiO₂ were weighed so as to have a molar ratio of 1.1 to 1.0, and NiO was further added thereto and mixed therewith so as to be 2 percent by weight. Next, pelletizing was performed after a binder was added to the mixture thus obtained, so that spherical pellets having a diameter of 2 to 5 mm were obtained.

Next, these granular pellets thus obtained were fired at 1,000° C. for 1 hour in air, so that a mixture of Ba₂TiO₄, BaTiO₃, and NiO was obtained.

Further, this mixture was fired at 700° C. for 1 hour in a stream containing 20% of CO₂ and 80% of N₂, thereby obtaining the carbon dioxide reforming catalyst F that was a mixture containing BaCO₃, BaTiO₃, and NiO.

From the weight change of the mixture before and after the firing and the result of XRD measurement, it was confirmed that the carbon dioxide reforming catalyst F thus obtained was a mixture of BaCO₃, BaTiO₃, and NiO.

It was also confirmed that from the above-described weight change before and after the firing and result of XRD measurement, that all Ba₂TiO₄ was decomposed into BaCO₃ and BaTiO₃, and that the molar ratio of BaCO₃ to BaTiO₃ was 0.1 to 1.0.

Also in the case of this carbon dioxide reforming catalyst F, at least part of the above NiO was reduced in a carbon dioxide reforming reaction step of a hydrocarbon feedstock gas so as to function as a catalytic metal promoting carbon dioxide reforming of a hydrocarbon feedstock gas.

### (7) Manufacturing of Carbon Dioxide Reforming Catalyst G

After a region of a green sheet was obtained by punching out or the like and was used to make a multilayer ceramic capacitor, the remaining part of the green sheet obtained thereby was degreased at 500° C., so that a ceramic powder containing 87% of BaTiO₃ was obtained. The ceramic green sheet contained Ba and Ti at a molar ratio (B/Ti) of 0.99 to 1.01, and included, as a primary component, a substance (BaTiO₃) having a perovskite structure as a primary crystalline structure.

In addition, as the balance of this ceramic powder, oxides of Ca, Zr, Si, Na, and Ni were primarily present.

Subsequently, after an amount of BaCO₃ was added to the above ceramic powder so as to obtain a Ba/Ti molar ratio of 2:1, and water was further added, mixing was performed using a ball mill for 2 hours, and the mixture thus obtained was then dried at 120° C. for 10 hours, followed by adding a binder, so that spherical pellets having a diameter of 2 to 5 mm were obtained.

Next, after the pellets obtained in the above step were degreased at 500° C. for 2 hours, firing was performed at 1,000° C. for 1 hour, so that a mixture containing Ba₂TiO₄ as a primary component and NiO contained as the balance of the above ceramic powder was obtained.

Subsequently, this mixture was fired at 700° C. for 1 hour in a stream containing 20% of CO₂ and 80% of N₂, thereby obtaining the carbon dioxide reforming catalyst G that was a mixture containing BaCO₃, BaTiO₃, and NiO.

From the weight change of the mixture before and after the firing and the result of XRD measurement, it was confirmed that the carbon dioxide reforming catalyst G thus obtained was a mixture of BaCO₃, BaTiO₃, and NiO.

This carbon dioxide reforming catalyst G functions as a carbon dioxide reforming catalyst containing a mixture of BaCO₃, BaTiO₃, and metal Ni as a primary component.

### Carbon Dioxide Reforming Test and Evaluation of Properties

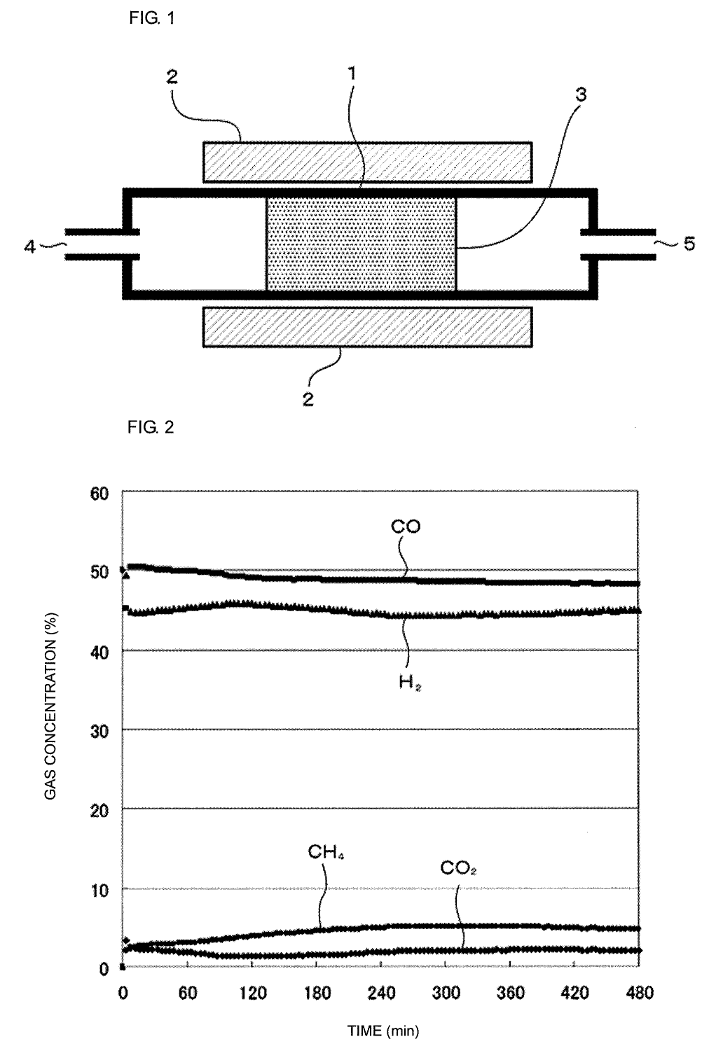

As shown in FIG. 1, after 50 cc of a carbon dioxide reforming catalyst 3 formed as described above was charged in a stainless steel-made reactor tube 1 which was provided with an external heater 2 and which had an inner diameter of 22 mm and a length of 300 mm, a mixed gas containing nitrogen and 20 percent by volume carbon dioxide was supplied through the reactor tube 1 at a rate of 25 ml/h from an inlet 4 thereof, and the mixed-gas inlet temperature was controlled at 900° C. by the heater. After the temperature of the mixed gas thus supplied was stabilized, instead of the above mixed gas, a mixed gas containing methane and carbon dioxide (CH₄:CO₂=1:1 (volume ratio)) was supplied at a rate of 25 ml/h, so that a reforming test was performed at 900° C.

Subsequently, a reformed gas which was discharged from an outlet 5 of the reactor tube 1 and which had been processed by carbon dioxide reforming was introduced into an analytical apparatus (gas chromatograph manufactured by Shimadzu Corporation), and the composition of the reformed gas was investigated.

After that test was finished, the carbon dioxide reforming catalyst was recovered out and was then sieved, so that the deposited carbon was recovered.

Furthermore, XRD measurement was performed for the carbon dioxide reforming catalyst that was recovered after the test was finished, so that its crystalline phase was identified.

In addition, for comparison purpose, a commercially available methane reforming catalyst H that contained NiO and alumina as primary components was prepared, and a carbon dioxide reforming test of methane was performed under conditions similar to those described above.

In Table 1, the composition of the obtained reformed gas, the weight of carbon powder recovered after the test was finished, and the crystalline phase of a carbon dioxide reforming catalyst obtained after the test was finished are shown.

In reforming Test No. 8 using a commercially available carbon dioxide reforming catalyst H, the reaction tube became clogged with deposited carbon approximately 1 hour after the start of this test, so that the test result obtained for 1 hour from the start to the clogging is only shown in Table 1.

FIG. 2 shows the change in composition of the reformed gas (outlet-side gas) over time in a reforming test using the carbon dioxide reforming catalyst C is shown.

TABLE 1

| | | Reformed Gas Composition | | | | | BaCO₃:BaTiO₃ | |
|---|---|---|---|---|---|---|---|---|
| | | H₂ | CO | CH₄ | CO₂ | Deposited | in Catalyst | Crystalline Phase |
| Test No. | Catalyst | (%) | (%) | (%) | (%) | Carbon (g) | (Molar ratio) | after Test |
| 1 | A | 46.5 | 48.5 | 3.5 | 1.5 | 3.5 | — | BaTiO₃, Ni |
| (Comparative | | | | | | | | |
| example) | | | | | | | | |
| 2 | B | 1.2 | 1.4 | 49.0 | 48.4 | 0 | — | BaCO₃, Ni |
| 3 | C | 44.9 | 48.0 | 5.2 | 1.9 | 0 | 1.0:1.0 | BaCO₃, BaTiO₃, Ni |
| 4 | D | 45.2 | 48.5 | 4.8 | 1.5 | 0 | 0.5:1.0 | BaCO₃, BaTiO₃, Ni |
| 5 | E | 46.1 | 48.8 | 4.3 | 1.3 | 0 | 0.2:1.0 | BaCO₃, BaTiO₃, Ni |
| 6 | F | 46.2 | 48.8 | 4.3 | 1.4 | 0.8 | 0.1:1.0 | BaCO₃, BaTiO₃, Ni |
| 7 | G | 48.1 | 47.6 | 2.6 | 1.7 | 0 | 1.0:1.0 | BaCO₃, BaTiO₃, Ni |
| 8 | H | 46.9 | 41.5 | 0.5 | 11.1 | 10 g≦ | — | Ni, other oxides |
| (Conventional | | | | | | | | |
| example) | | | | | | | | |

As noted above, the reforming test of Test No. 8 using the commercially available carbon dioxide reforming catalyst H had the reaction tube clogged with deposited carbon approximately 1 hour after the start of the test.

On the other hand, it was confirmed in the reforming Test Nos. 3, 4, and 5 using carbon dioxide reforming catalysts satisfying the points of the present invention, C, D, and E in which NiO was added to a mixed material of BaCO₃ and BaTiO₃, that a high conversion rate of CH₄ (methane) and CO₂ (carbon dioxide) was ensured without generating carbon deposition, and that carbon monoxide (CO) and hydrogen (H₂) could be efficiently manufactured from CH₄ and CO₂.

In Test No. 6 using the catalyst F, also confirmed that a high conversion rate of CH₄ and CO₂ was obtained. However, a small amount of deposited carbon was observed.

Furthermore, in reforming Test No. 7 using the carbon dioxide reforming catalyst G containing a mixture of BaCO₃, BaTiO₃, and NiO as a primary component, that was manufactured using scrap green sheet that contained Ba₂TiO₄ as a primary component and NiO, confirmed that a high conversion rate of CH₄ and CO₂ was obtained. In addition, no carbon deposition was observed until the end of the reforming test.

Although the conversion rate of CH₄ and CO₂ was not high, in reforming Test No. 2 using a carbon dioxide reforming catalyst satisfying the points of the present invention, that is, carbon dioxide reforming catalyst B in which BaCO₃ and NiO were contained, carbon deposition was not observed. Incidentally, as with this carbon dioxide reforming catalyst B, also when a carbon dioxide reforming catalyst containing, as a primary component, an alkaline earth metal carbonate, such as BaCO₃, and a catalytic metal and which does not contain ATiO₃ (when A is at least one of Ca, Sr, and Ba), such as BaTiO₃, is used, the type of catalytic metal, the addition amount thereof, and conditions for a reforming reaction can be appropriately adjusted so that the conversion rate of CH₄ and CO₂ can be increased while carbon deposition is suppressed.

In reforming Test No. 1 using a carbon dioxide reforming catalyst not satisfying the points of the present invention, that is, carbon dioxide reforming catalyst A in which BaTiO₃ and NiO were contained, although the conversion rate of CH₄ and CO₂ was high, it was confirmed that the amount of deposited carbon was unfavorably large, such as 3.5 g.

In the case of a carbon dioxide reforming catalyst of the present invention in which NiO was added to a mixed material of BaCO₃ and BaTiO₃, and even in the reforming Test 6 using the carbon dioxide reforming catalyst F in which the ratio of BaCO₃ was small (molar ratio of BaCO₃ to BaTiO₃ was 0.1:1.0), the amount of deposited carbon was 0.8 g, that is, the amount of deposited carbon was significantly decreased as compared to 3.5 g deposited carbon obtained in the above Test No. 1 using the carbon dioxide reforming catalyst (mixture of BaTiO₃ and NiO) A in which BaCO₃ was not present. Hence, according to the present invention, the amount of deposited carbon can be decreased, and the life of a carbon dioxide reforming catalyst can be increased.

In all of the reforming tests of Test Nos. 1 to 7, it was confirmed that a Ni component was present as a metal on the surface of the catalyst that was recovered after the test, and hence it is found that the reason the decomposition of a hydrocarbon, such as CH₄ (methane), is promoted by the carbon dioxide reforming catalyst of the present invention is due to the catalytic metal (Ni) being present on the surface.

In the carbon dioxide reforming catalyst of the present invention, besides the Ni used as the catalytic metal of the above examples, a metal such as Rh, Ru, Ir, Pd, Pt, Re, Co, Fe, or Mo, that has been known to be effective to promote carbon dioxide reforming of a hydrocarbon, such as CH₄, may be used, and also in this case, an effect similar to that of the above examples can be obtained.

In order to suppress carbon deposition while a high conversion rate (high activity) is ensured, it is found from Table 1 that the ratio (molar ratio) of BaCO₃ to BaTiO₃ is preferably set such that BaCO₃:BaTiO₃=1.0:1.0 to BaCO₃:BaTiO₃=0.2:1.0.

However, the present invention is not limited to the above examples, and the manufacturing method of a carbon dioxide reforming catalyst, the type of alkaline earth metal forming a carbon dioxide reforming catalyst, the type of A forming ATiO₃, the content amount of a catalytic metal, the concrete conditions of a reforming reaction when the carbon dioxide reforming catalyst of the present invention is used, and the like may be variously changed and modified without departing from the scope of the present invention.

### INDUSTRIAL APPLICABILITY

As thus has been described, the present invention provides a carbon dioxide reforming catalyst that enables a hydrocarbon feedstock gas to react with carbon dioxide while carbon deposition is suppressed and that can efficiently generate hydrogen and carbon monoxide, i.e., can perform carbon dioxide reforming, and by using the above catalyst, a synthetic gas containing hydrogen and carbon monoxide can be efficiently manufactured.

Hence, the present invention can be widely applied to the field of a carbon dioxide reforming catalyst and also to various technical fields in which a synthetic gas containing hydrogen and carbon monoxide is manufactured and/or is used.

1. A carbon dioxide reforming catalyst which reforms a hydrocarbon feedstock gas by carbon dioxide and can be used to generate a synthetic gas containing carbon monoxide and hydrogen, comprising:
a mixture comprising a carbonate of at least one alkaline earth metal selected from the group consisting of Ca, Sr, and Ba, and a catalytic metal which promotes a decomposition reaction of a hydrocarbon feedstock gas.

2. The carbon dioxide reforming catalyst according to claim 1, wherein the catalytic metal is at least one member selected from the group consisting of Ni, Rh, Ru, Ir, Pd, Pt, Re, Co, Fe, and Mo.

3. The carbon dioxide reforming catalyst according to claim 2, further comprising ATiO₃ in which A is at least one alkaline earth metal selected from the group consisting of Ca, Sr, and Ba.

4. The carbon dioxide reforming catalyst according to claim 3, in which the alkaline earth metal carbonate comprises barium carbonate and A comprises Ba.

5. The carbon dioxide reforming catalyst according to claim 4 in which the molar ratio of the carbonate to ATiO₃ is 0.1:1 to 1:1.

6. The carbon dioxide reforming catalyst according to claim 5 in which the catalytic metal comprises Ni.

7. The carbon dioxide reforming catalyst according to claim 4 in which the catalytic metal comprises Ni.

8. The carbon dioxide reforming catalyst according to claim 1, further comprising ATiO₃ in which A is at least one alkaline earth metal selected from the group consisting of Ca, Sr, and Ba.

9. The carbon dioxide reforming catalyst according to claim 8, in which the alkaline earth metal carbonate comprises barium carbonate and A comprises Ba.

10. In a method for manufacturing a synthetic gas containing carbon monoxide and hydrogen by carbon dioxide reforming of a hydrocarbon feedstock gas employing a reforming catalyst, the improvement which comprises utilizing as the reforming catalyst, a carbon dioxide reforming catalyst according to claim 1.

11. In a method for manufacturing a synthetic gas containing carbon monoxide and hydrogen by carbon dioxide reforming of a hydrocarbon feedstock gas employing a reforming catalyst, the improvement which comprises utilizing as the reforming catalyst, a carbon dioxide reforming catalyst according to claim 2.

12. In a method for manufacturing a synthetic gas containing carbon monoxide and hydrogen by carbon dioxide reforming of a hydrocarbon feedstock gas employing a reforming catalyst, the improvement which comprises utilizing as the reforming catalyst, a carbon dioxide reforming catalyst according to claim 3.

13. In a method for manufacturing a synthetic gas containing carbon monoxide and hydrogen by carbon dioxide reforming of a hydrocarbon feedstock gas employing a reforming catalyst, the improvement which comprises utilizing as the reforming catalyst, a carbon dioxide reforming catalyst according to claim 4.

14. In a method for manufacturing a synthetic gas containing carbon monoxide and hydrogen by carbon dioxide reforming of a hydrocarbon feedstock gas employing a reforming catalyst, the improvement which comprises utilizing as the reforming catalyst, a carbon dioxide reforming catalyst according to claim 6.

15. A support for a carbon dioxide reforming catalyst comprising a carbonate of at least one alkaline earth metal selected from the group consisting of Ca, Sr, and Ba, and ATiO₃ in which A is at least one alkaline earth metal selected from the group consisting of Ca, Sr, and Ba.

16. (canceled)

17. The support for a carbon dioxide reforming catalyst according to claim 15, in which the alkaline earth metal and A comprise Ba.

18. A method for manufacturing the carbon dioxide reforming catalyst according to claim 1, comprising absorbing carbon dioxide in an alkaline earth metal/Ti composite oxide having a carbon dioxide absorption ability.

19. A method for manufacturing the carbon dioxide reforming catalyst according to claim 17, in which the alkaline earth metal/Ti composite oxide is Ba₂TiO₄.

20. A method for manufacturing the carbon dioxide reforming catalyst support according to claim 15, comprising absorbing carbon dioxide in an alkaline earth metal/Ti composite oxide having a carbon dioxide absorption ability.

21. A method for manufacturing the carbon dioxide reforming catalyst according to claim 20, in which the alkaline earth metal/Ti composite oxide is Ba₂TiO₄.
